(19) United States
(12) Patent Application Publication
(10) Pub. No.: US 2007/0298139 A1
(43) Pub. Date: Dec. 27, 2007

(54) Compression Mould With Deformable Cavity Wall

(75) Inventors: Alessandro Balboni, Granarolo Dell'Emilia (IT); Fiorenzo Parrinello, Medicina (IT); Zeno Zuffa, Bogo Tossignano (IT)

Correspondence Address: BROWDY AND NEIMARK, P.L.L.C.;624 NINTH STREET, NW, SUITE 300, WASHINGTON, DC, 20001-5303, US

(73) Assignee: SACMI COOPERATIVA MECCANICI IMOLA SOCIETA' COOPERATIVA, Imola, Bologna (IT)

(21) Appl. No.: 11/664,602

(22) PCT Filed: Sep. 8, 2005
(86) PCT No.: PCT/IB05/02655

§ 371 Date: Apr. 3, 2007

(30) Foreign Application Priority Data
Oct. 12, 2004 (IT) RE2004A000126

(51) Int. Cl. B29C 43/36

(52) U.S. Cl. 425/390; 264/299; 428/35.7

(57) ABSTRACT

The mold comprises a matrix (30) and a punch (20) adapted to penetrate into the cavity of the matrix to determine the molding chamber of the mold, the object being formed through the pressure insertion of the punch (20) within the cavity of the matrix (30) where a metered body (8) of polymeric material has been previously placed whose mass is metered according to a reference value. According to the invention, the matrix (30) comprises at least one deformable wall (31) whose inner surface defines at least part of the surface of the matrix (30), said deformable wall (31) having, at least in part, a relatively thin thickness which permits it to be elastically deformed under the pressure of the polymeric material in the final molding step of the object, thereby absorbing the error of the mass of the metered body (8) with respect to the reference value.

### TECHNICAL FIELD

The present invention relates to the compression molding of objects in polymeric material, through a mold comprising a matrix and a punch adapted to penetrate into the cavity of the matrix to determine the mold's molding chamber.

A typical, but not exclusive application of the invention is to form closing capsules for plastic containers of mineral water, fizzy drinks or similar items, having generally cylindrical form with a tubular portion closed by a usually more or less flat bottom element.

### PRIOR ART

According to the known art, to form the object it is first of all foreseen the insertion, within a rigid (metallic) matrix, of a metered body of polymeric material whose mass is metered according to a reference value, and, subsequently, the pressure insertion of a punch within the same matrix until it closes the mold's molding chamber, i.e. the chamber which, when the mold is in closed position, remains between the punch and the inner surface of the matrix and defines the shape of the object.

A technical problem, present in the described technology and connected with said molds, arises from the fact that, in the metering of the body of polymeric material (metering) to be inserted into the matrix (typically through the separation of the body from a continuous and unshaped mass supplied by an extruder means), (small) value differences with respect to the predetermined reference value are inevitably obtained, while the volume of the (closed) chamber of the mold, which needs to be completely filled with the polymeric material to form the object, is instead constant for each mold; there exists therefore the technical problem of compensating the inexactness of the mass of the metered body with respect to the reference value.

To such end it is known to foresee in the matrix one or more movable parts which permit the absorption of the metering error in a more or less relatively restricted portion of the object.

In the case of said closing capsules for plastic bottles, the error is compensated by concentrating the excess metering above all in the bottom element.

Consequently the thickness of this element undergoes uncontrolled and also substantial size variations which may involve technical problems in some working steps subsequent to the molding, in which the inner surface of the bottom element is utilised as reference surface for the positioning of machine elements, in that the geometrical position of such surface with respect to the capsule is not constant (due to the variation of the relative axial position between the inner and outer surfaces).

### STATEMENT OF THE INVENTION

One object of the present invention is to improve the problem of absorption of the metering error and in particular to solve said technical problem related to the closing capsules, through a valid and effective solution.

Another technical problem which the invention proposes to solve is to render more effective and rapid the removal of the heat which is placed in action during the molding and afterwards to increase the consistency of the object and to permit its extraction from the mold.

This requirement is particularly important in order to render the fabrication cycle of the object more rapid, above all for molds operated with a continuously functioning rotating turntable machine in that, thanks to the invention it is possible to diminish the cooling time and consequently increase the general operative velocity of the entire machine.

Said and other objects are achieved by the invention thereof as is characterised in the claims.

According to the invention, the compensation of the error of the metering mass in the molding of the object is realised with an elastic deformation of at least one part of the matrix's inner surface. The reference value of the mass of the metered body is calculated such that, the error taken into account, the metered body has a mass such to always and in a complete manner fill the volume, calculated “in unloaded condition” (i.e. in conditions of inactivity of the mold), of the molding chamber of the mold and that the error proves to be an excess of polymeric material with respect to the volume of the chamber itself. In the subsequent step of object molding, due in fact to the presence of said excess of polymeric material and thanks to the structural characteristics of the matrix, at least part of the inner surface of the matrix elastically deforms (to an extent which varies in relation with the size of the error) with respect to the shape which the same possesses “in unloaded condition”, consequently increasing the size of the object with respect to the same size “in unloaded condition”.

The excess polymeric material is thus distributed in a more homogenous and regular manner in the body of the object; in particular, it may be done such that it is distributed over a relatively very wide body part to give rise to an error, in the dimensions involved, of modest or even imperceptible value.

The matrix part which, as said above, elastically deforms is adapted to resist to such deformation so that the polymeric material achieves in the final molding step a pressure of value substantially equal to the pre-established design value.

Moreover, the transmission of the heat through the deformable wall is very much favoured by the relatively very thin thickness of the wall itself, with the consequence that the cooling (or in any case any conditioning) of the object may be rendered faster.

### BRIEF DESCRIPTION OF THE DRAWINGS

Further details of the invention are described below with the aid of the attached figures which illustrate, as an example, an embodiment of a mold for the molding of a closing capsule for plastic containers.

FIG. 1 is an axial section of the mold according to the invention, in closed position.

FIG. 1A is a detail of FIG. 1.

FIG. 2 is a perspective view of the deformable wall of FIG. 1.

FIG. 3 is a plan view from below of the deformable wall of FIG. 2.

FIGS. 4A-4D show the mold of FIG. 1 in a succession of steps during the molding of the object.

FIG. 5 shows, in perspective view, an example of the capsule which is obtained with the mold of FIG. 1.

### DETAILED DESCRIPTION OF THE INVENTION

The mold illustrated in the figures and in the description which follows is set to form a closing capsule for plastic containers; however the shape of the object which may be obtained with the invention may be of any form.

The capsule 10 illustrated in the figures is a capsule of well known traditional type, for bottles of thermoplastic resin PET, and comprises a lateral tubular portion 11, substantially cylindrical, closed by a substantially flat bottom element (bottom) 12.

Along the inner surface of the tubular portion 11 common helicoidal projections are placed which form a thread 13 for screwing the capsule on the neck of the bottle. Along the outer wall of the portion 11 common vertical reliefs 111 are placed which form a knurling. Along the inner surface of the bottom 12 a common annular relief 14 is placed of axial form. Also foreseen is a common annular guarantee band 15 formed of an upper and lower portion united between a thin section.

The object 10 (capsule) is realised with a process of compression molding through the pressure insertion of a punch 20 (male mold element) within a closed-cavity hollow matrix (female mold part), loaded with a metered body 8 of polymeric material (in particular a thermoplastic resin) at the more or less viscous pasty state, whose mass is metered according to a reference value.

The molding machine which the mold utilises according to the invention is typically, though not exclusively, of the continuously rotating turntable type, and typically but not exclusively operates with a plurality of equal molding groups which are driven in sequence.

In the figures only a generic mold according to the invention is illustrated. The machine, on the other hand, is not illustrated, being per se of traditional type. The mold comprises a matrix 30 and a punch 20. Together, punch 20 and cavity of the matrix 30 form a molding chamber 7 which confers the desired form to the object. In the case of a concave object (like the described closing capsule 10), the matrix cavity confers shape to all or most of the outer surface of the object while the outer surface of the punch confers shape to all or most of the inner surface of the object.

According to the embodiment illustrated in the figures, the matrix 30 of the mold possesses a continuous and concave inner surface 30a, which forms the matrix cavity.

The punch 20 is formed, as known, by several parts, in relation with the complexity of the form of the capsule 10, to realise the molding and the successive delivery of the capsule 10 itself.

In detail, the punch 20 comprises a central element 21 whose lower surface 21a defines the central part of the inner surface of the bottom 12. Coaxially coupled to the central element 21 is a first tubular element 22 whose lateral surface defines the shape of the inner surface of the tubular portion 11 of the capsule (with related threads 13). Moreover in the lower zone of the elements 21 and 22, these give shape to the annular relief 14.

Along the outer surface of the element 22 a second tubular element 23 is coupled, on whose outer surface a third tubular element 24 is coupled; finally, a fourth tubular element 25 is coupled to the outer surface of the element 24.

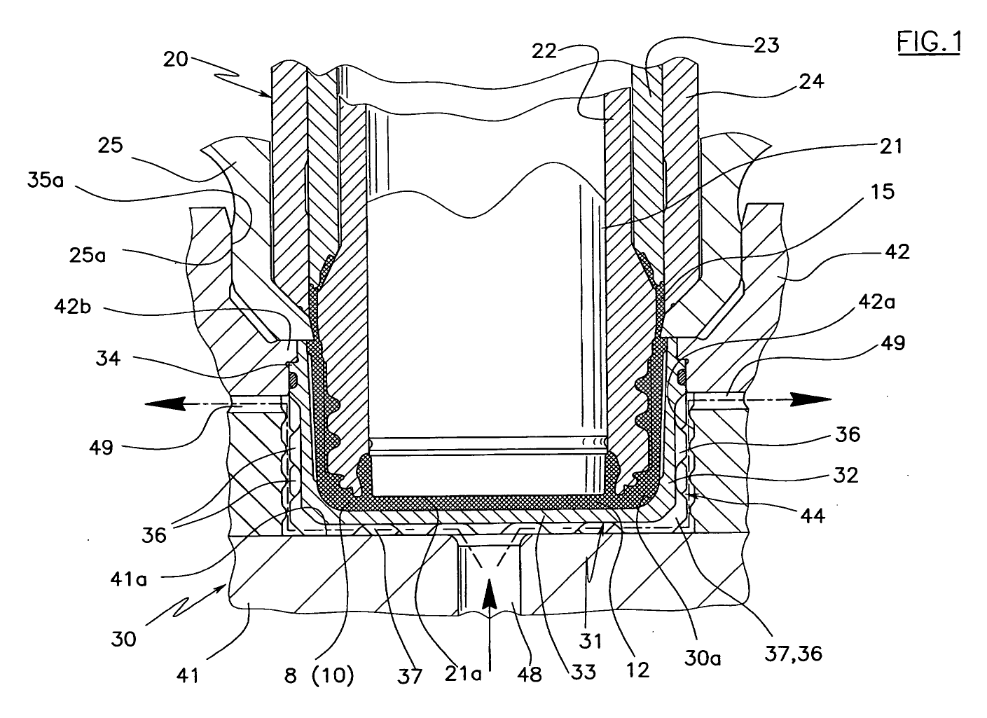

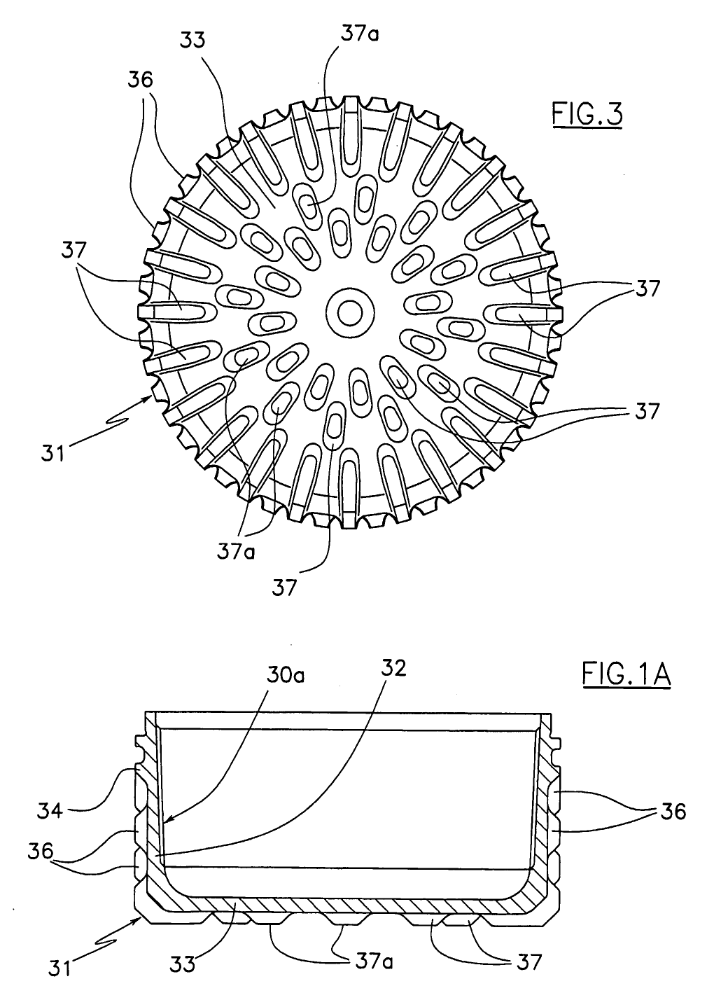

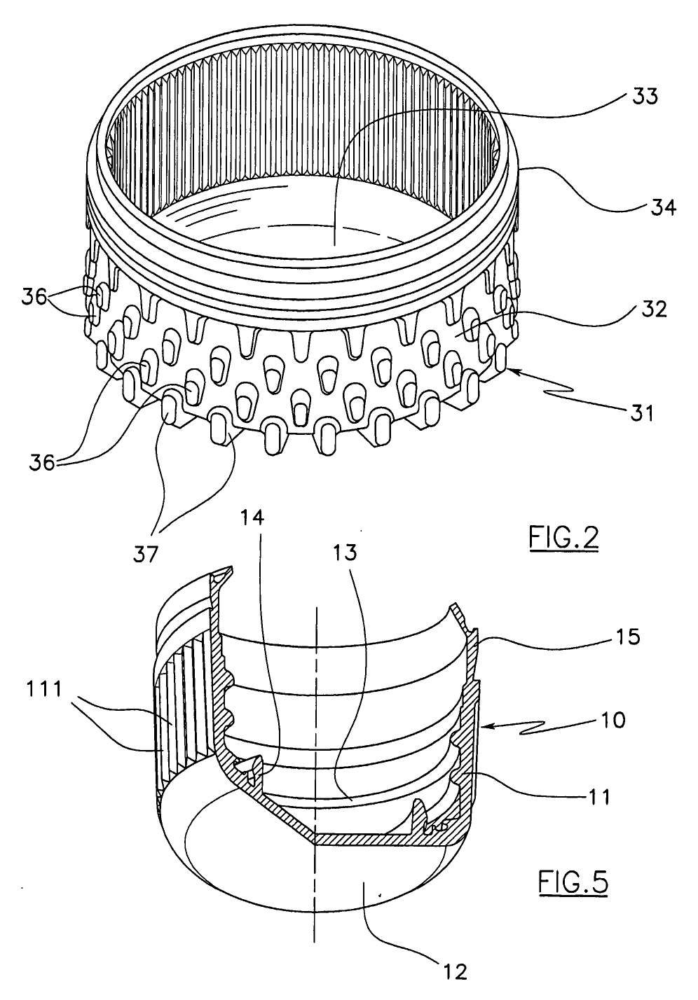

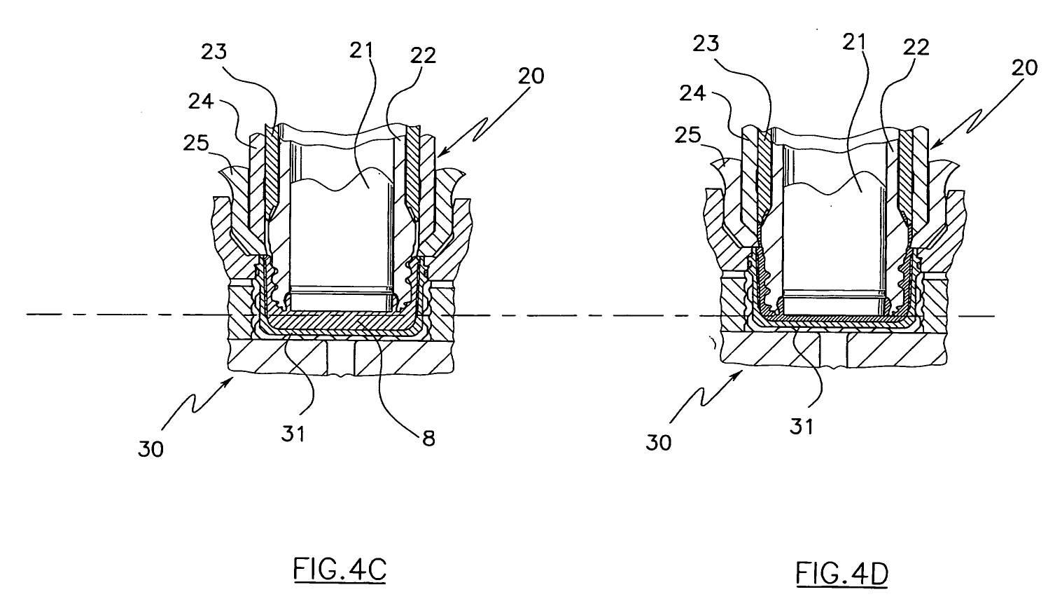

In closed mold configuration (as illustrated in FIG. 1), all of the elements 21, 22, 23, 24 and 25 are associated with each other in a compact position and relatively close to the lower surface 21a of the central element 21 and together give complete shape to the capsule illustrated in FIG. 5. Moreover, in this configuration, the outermost tubular element 25 perfectly inserts itself, with its outer cylindrical surface 25a, in contact with a corresponding inner cylindrical surface 35a of an upper cavity 35 of the matrix 30, obtained in the upper part thereof.

Naturally, the invention also applies to molds having a punch different from that described above, for example, in the molding of closing capsules, with a punch whose centring elements with the matrix are realised with frustoconical surfaces. According to the invention, the matrix 30 comprises an undeformable support body which contains in its own interior at least one deformable wall 31 whose inner surface defines at least part of the inner surface 30a of the matrix, said deformable wall 31, having at least in part a relatively thin thickness which permits it to be elastically deformed (in particular deformed by bending along the section of the generic axial plane) under the pressure of the polymeric material in the final step of the object molding, thereby increasing the thickness of the capsule.

Said deformable wall 31 is in steel or other equivalent material.

According to the embodiment illustrated in the figures, the deformable wall 31 comprises a lateral portion 32 having a tubular shape, whose inner surface determines the shape of the outer surface of the tubular portion 11, and a (horizontal) portion 33 transverse to the axis of the punch 20, whose inner surface determines the shape of the outer surface of the bottom 12.

Said portions 32 and 33 are joined together in a single body and their inner surface defines the entire inner surface 30a of the matrix. The inner wall 31, and therefore the two portions 32 and 33, possess a relatively thin thickness which renders it elastically deformable to the pressure to which it is subjected by the polymeric material in the molding step. The deformable wall 31 comprises however a section enlargement which defines a circular band 34 near the upper end of the wall 31 itself.

The deformable wall 31 is enclosed within a coaxial cavity 44 made in the support body of the matrix 30, whose inner surface is placed at a distance from the outer surface of the wall 31 (that is at a distance from both the lateral portion 32 and the transverse portion 33), such that this may be radially deformed without being hindered by the body itself.

In detail, in the embodiment illustrated in the figures, said support body is composed of a lower body 41 having a flat and horizontal upper surface and an upper body 42 which adheres to the upper surface of the body 41. Said coaxial cavity 44 is defined between the two bodies 41 and 42.

The upper body 42 possesses a cylindrical cavity whose inner surface 42a defines the lateral surface of the coaxial cavity 44, while the lower body 41 has a flat upper surface 41a which defines the lower surface of the coaxial cavity 44.

The outer surface of the coaxial band 34 is placed radially in contact with the lateral surface 42a and has a cavity which comes into axial contact with a shoulder 42b, turned downward, foreseen in the upper end portion of the cavity 44.

The circular band 34 and its contact with the lateral surface 42a confer a fixed and stable centring, in radial direction, of the deformable wall 31.

The cavity 44 is connected, through a lower conduit 48 and other exit conduits 49, with means adapted to introduce, circulate and discharge conditioning fluids capable of removing heat from the deformable wall 31 and therefore from the object 10 to carry out a thermal conditioning (cooling) of the same.

The deformable wall 31 lends itself in a particular manner to this end thanks to the fact that it possesses a relatively very thin thickness, which greatly favours the transmission of heat through it.

Moreover the same wall 31 may have different reliefs 36 and 37 placed on its own outer surface which define the elements of thermal exchange. In detail, reliefs 36 are foreseen on the lateral portion 32 and reliefs 37 on the transverse portion 33.

The reliefs 36 are interrupted along the circumferential direction so as not to hinder the radial elastic dilation of the lateral portion 32 in the molding step.

In the embodiment illustrated in the figures the reliefs 36 have the shape of fins which depart radially from the lateral portion 32 and extend for a limited distance in the axial direction; these reliefs are moreover placed in alternate manner between one line and the other in order to realise the maximum turbulence in the passage of the conditioning fluid and therefore maximise the thermal exchange with the wall.

The reliefs 37 placed on the transverse portion 33 have the shape of fins which depart axially from the portion 33 itself and extend for a limited distance in the radial direction. The reliefs 37 are also placed in alternate manner between one line and the other in order to realise the maximum turbulence in the passage of the conditioning fluid.

The reliefs 37 placed on the outer surface of the transverse portion 33 have their own free end surface 37a which abuts against the lower surface 41a of the coaxial cavity 44. The deformable wall 31 is therefore axially blocked between the shoulder 42b with which it comes into contact through the circular band 34 and the lower surface 41a with which it comes into contact through the lower reliefs 37.

On the other hand, the free end portion of the reliefs 36 placed on the outer surface of the lateral portion 32 remains a distance from the lateral surface 42a of the cavity 44 so that the radial elastic deformation (bending) of the portion 32 is not hindered. The deformable wall 31 remains radially constrained by the upper body 42 through the single circular band 34.

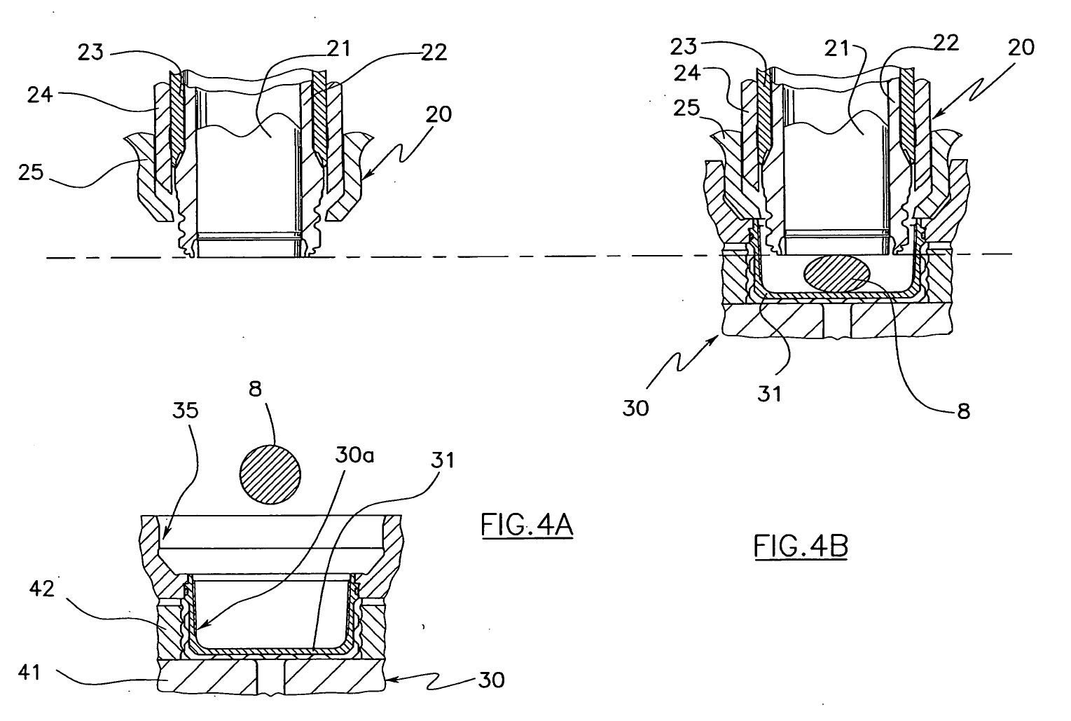

In operation, it is first foreseen (FIG. 4A) to insert a metered body 8 of polymeric material in the cavity of the matrix 30, whose mass is metered according to a reference value which is established such that, taken into account the error which inevitably exists in the metering of such body, the body 8 itself always fills in a complete manner the volume of the molding chamber 7 of the mold calculated “in unloaded condition”, and that the error proves to be an excess of polymeric material with respect to the volume of the chamber itself.

Subsequently, the mutual approaching of the mold components is carried out, for example, following a lifting of the matrix 30, operated through a lower device (not illustrated in the figures) while the punch 20 remains still.

In the figures from 4A to 4D a horizontal reference axis which remains fixed is indicated with X, which matches with the lower surface 21a of the punch 20.

It is nevertheless obvious that that of importance here is the movement related to the mutual approaching; this may be obtained, alternatively, following a downward movement of the punch 20 possibly together with an upward movement of the matrix 30.

First, following an upward displacement of the matrix 30, the lower end of the outermost tubular element 25 penetrates into the cavity 35 until it comes into contact with the cavity's lower surface area (FIG. 4B) and the punch begins to penetrate into the matrix cavity, beginning to deform the metering 8.

Subsequently (FIG. 4C) the punch continues to penetrate (always following the upward displacement of the matrix 30) within the matrix cavity, deforming the metering 8 which assumes the shape of the cavity wherein it is shut, until it produces the complete closing of the mold which is verified when the tubular elements 22, 23, 24 and 25 are in the configuration of maximum mutual approach to definitively define the molding chamber 7 (position illustrated in FIG. 4D). At this point the penetration of the punch comes to an end.

In this final step of object molding, it occurs that first, when the molding chamber 7 is still not closed, the polymeric material of the metering completely fills such chamber 7, while the deformable wall 31 has not yet been deformed, at least not to a perceptible extent, achieving appropriately high pressure values in the range of design values foreseen at the end of the molding. Then, the penetration of the punch in the cavity of the matrix continuing further until the closing of the mold, since the polymeric material has an excess volume with respect to the volume of the molding chamber 7, such material, pushed by the pressure produced by the penetration of the punch, causes the elastic wall 31, whose generic axial section is free to bend and be elastically deformed with outward radial displacement, to absorb the excess volume with respect to the volume of the molding chamber 7.

The reference value of the mass of the metering 8 is calculated such that taking into account both the error in the formation of the metering 8 and the volumetric shrinkage which occurs in the cooling of the object during molding, the complete filling of the molding chamber 7 is realised and moreover such that the polymeric mass is subjected, in molding, to a pressure having appropriate design values (on the order of several hundred bar).

For its own part deformable wall 31 is designed with structural characteristics (in particular the material and the thickness in relation with the length) such to be elastically deformed in such a manner as to absorb the excess volume of the metering and provide at the same time, in virtue of its own structural characteristics (without the intervention of external means or operations), a sufficient resistance to the elastic deformation to allow that the polymeric material of the metering achieves, in the final molding step, said design values relating to the pressure, where moreover the deformation of the wall 31 takes place following the complete filling on the molding chamber.

Therefore, the deformable wall 31 will be sized in relation with several parameters including the size of the pressing forces involved and the size of the errors of the metering.

Therefore, the lateral portion 32, deforms itself by bending in a radial direction, not finding impediments in the cavity 44 wherein it is enclosed. In particular, the deformation which the lateral portion 32 undergoes is a bending in the section along the generic axial plane, with displacement in the middle zone inflected outward. On the other hand, along the generic transverse plane, the deformation consists in an increase in the diameter of the lateral wall 32, having maximum value in correspondence with the axially middle zone.

The transverse portion 33 is instead in axial contact with the lower surface 41a through the fins 37. The portion 33 may nevertheless undergo limited bending deformations in the free zones interposed between one fin 37 and another and between the rows of fins 37 themselves.

Other deformations (to a limited extent) of the transverse portion 33 occur also due to the fact that the end surfaces 37a of the fins 37, in particular those fins 37 which are placed in the central part of the portion 33, have a relatively small extension such to undergo, under the operative pressure, a deformation by axial compression which permits in fact a relatively small elastic bending (in axial direction) of this central part of portion 33 which bear said fins 37.

The fins 37 placed in the outer peripheral part of the portion 33 are instead of preferably greater size such to practically not deform themselves and therefore maintain the lateral portion 32 axially stopped.

Alternatively it may be foreseen that the central zone of the portion 33 lacks the fins 37 or that these do not come into contact “in unloaded condition” with the surface 41a.

The error of the mass of the metering is therefore distributed over the part of the object placed in correspondence with the deformable wall 31 and hence more or less over the entire body of the capsule 10 (to a greater degree in the tubular portion 11). For example, for an object having a mass of 2.3 grams, and total axial length of 20 mm, a deformable wall 31 was utilised, in the matrix, of stainless steel, with low levels of carbon and high levels of Mo, Ni, Co and Ti, whose thickness in the central part is 1.5 mm. In the test operation, foreseeing for the mass of the metered body 8 a maximum error of 2%, radial deformations were found in the wall 31 on the order of 0.02-0.05 mm.

In the embodiment illustrated in the figures, the lateral portion 32 and the transverse portion 33 are joined together in a single body with continuity.

Alternatively it may be foreseen that the deformable wall 31 comprises a lateral portion separated from said transverse portion and nevertheless joined to it to form continuity with the respective inner surfaces.

Still alternatively, it may be foreseen that the deformable wall 31 comprises only said lateral portion or only said transverse portion and that the remaining part of the inner surface of the matrix is defined as an undeformable body.

Moreover, above all in the case in which the error in the mass of the metering may be relatively very high, it may be foreseen that the compensation of such error is carried out through the elastic deformation of the deformable wall 31 together with the obtainable compensation, as from traditional technique, by varying the relative axial position between the female part (matrix) and male part (punch) at the end of the molding. In particular, according to the illustrated embodiment, the compensation of traditional type occurs by varying the final relative axial position between the female part, comprising the lower body 41, the upper body 42, the tubular element 25 and the tubular element 24, and the male part, comprising the central punch element 21 and the two tubular elements 22 and 23.

Even if the description of the invention was completed with reference to the molding of a closing capsule for plastic bottles, the present invention may find convenient application for the molding of an indeterminate variety of objects of different shape.

1. Mold for the compression molding of objects in polymeric material, comprising a matrix (30) and a punch (20) adapted to penetrate into the cavity of the matrix to determine the molding chamber of the mold, the object being formed through the pressure insertion of the punch (20) within the cavity of the matrix (30) where a metered body (8) of polymeric material has been previously placed whose mass is metered according to a reference value,
characterised in that the matrix (30) comprises at least one deformable wall (31) whose inner surface defines at least a part of the surface of the matrix (30), said deformable wall (31) having, at least in part, a relatively thin thickness which permits it to be elastically deformed under the pressure of the polymeric material in the final step of the object molding, thereby absorbing the error in the mass of the metered body (8) with respect to the reference value.

2. Mold according to claim 1, characterised in that said deformable wall (31) is adapted to be elastically deformed under the pressure of the polymeric material in the final molding step, thereby increasing the thickness of the object so to absorb the error of the metering mass.

3. Mold according to claim 1, characterised in that said deformable wall (31) comprises at least one lateral portion (32) having a tubular shape and/or at least one portion (33) transverse to the axis of the punch (20).

4. Mold according to claim 1, characterised in that the deformable wall (31) is enclosed within a coaxial cavity (44) made in the support body (41, 42) of the matrix, whose inner surface (41a, 42a) is placed a distance from the outer surface of the deformable wall (31), such that this may be deformed without being hindered by the support body (41, 42) itself.

5. Mold according to claim 4, characterised in that said deformable wall (31) has, in at least one of its parts, reliefs (37) placed along the outer surface, whose end surface (37a) abuts against the inner surface of said coaxial cavity (44), said end surfaces (37a) extending such to undergo a deformation by compression which permits the bending of the part (33) of the deformable wall (31) which bears said reliefs (37).

6. Mold according to claim 1, characterised in that said deformable wall (31) is adapted to resist the elastic deformation in virtue of its own structural characteristics and so that the polymeric material achieves in the final molding step a pressure level substantially equal to the pre-established design level.

7. Mold according to claim 6, characterised in that said deformable wall (31) is adapted to resist the elastic deformation so that the deformation takes place following the complete filling of the molding chamber (7).

8. Mold according to claim 6, characterised in that said deformable wall (31) is realised in steel or equivalent material and its deformation occurs by bending in the section along the generic axial plane, without appreciable variations of its thickness.

9. Mold according to claim 1, characterised in that said deformable wall (31) has reliefs (36, 37) placed along the outer surface, which define elements of thermal exchange, interrupted along the circumferential direction in order not to hinder the elastic deformation of the deformable wall (31).

10. Mold according to claim 3, characterised in that it comprises reliefs (36) placed along the lateral portion (32) having the shape of fins which project radially and extend for a distance in the axial direction, said reliefs (36) being moreover placed in alternate manner between one line and the other in order to realise the maximum turbulence in the passage of the cooling fluid.

11. Mold according to claim 3, characterised in that it comprises reliefs (37) placed along the transverse portion (33) having the shape of fins which project axially and extend for a distance in the radial direction, said reliefs (37) being moreover placed in alternate manner between one line and the other in order to realise the maximum turbulence in the passage of the cooling fluid.

12. Object in polymeric material, formed through the pressure insertion of a punch (20) within the cavity of a matrix (30) where a metered body (8) of polymeric material is placed whose mass is metered according to a reference value, characterised in that the excess mass, produced in the metering of the metered body (8) with respect to the reference value of the mass, is distributed over the body of the object.

13. Method for the compression molding of objects in polymeric material through the mold according to claim 1, characterised in that:
the reference value of the mass of the metered body is calculated such that, taken into account the metering error, the metered body always fills in a complete manner the volume of the molding chamber and that the error results as an excess of polymeric material with respect to the volume of the chamber itself,
in the final step of the molding of the preform first the polymeric material of the metering completely fills the molding chamber (7) and
subsequently, the penetration of the punch continuing further into the cavity of the matrix until the closing of the mold, the excess volume of the polymeric material with respect to the volume of the molding chamber (7), pushed by the pressure produced by the penetration of the punch, causes the elastic wall (31) to be elastically deformed until it absorbs said excess volume.
